(19) United States
(12) Patent Application Publication
(10) Pub. No.: US 2003/0068128 A1
(43) Pub. Date: Apr. 10, 2003

(54) Interferometer apparatus and method

(76) Inventors: Michael Kevan Durkin, Southampton Hampshire (GB); Mikhail Nickolaos Zervas, Southampton Hampshire (GB)

Correspondence Address: FINNEGAN, HENDERSON, FARABOW, GARRETT &, DUNNER LLP, 1300 I STREET, NW, WASHINGTON, DC, 20006, US

(21) Appl. No.: 10/149,605

(22) PCT Filed: Dec. 13, 2000
(86) PCT No.: PCT/GB00/04786

(30) Foreign Application Priority Data
Dec. 15, 1999 (EP) 99310111.2

(51) Int. Cl. G02B 6/34

(52) U.S. Cl. 385/37

(57) ABSTRACT

An interferometer comprising a beam source (PM, M1, L1) of first and second light beams. The interferometer has a first arm that routes the first light beam via a first pair of mirrors (M4, M5) arranged at right angles to each other in the manner of a corner cube to reverse the direction of the first light beam and a second arm that routes the second light beam via a second pair of mirrors (M2, M3). The beam source (PM, M1, L1) and the second mirror pair (M2, M3) are mounted on a linear translation stage (P1). The first and second light beams are incident on a focusing element (L2) symmetrically about and parallel to its optical axis and then converge at an angle (φ) to form an interference pattern. The symmetric, balanced configuration of the interferometer is retained under motion of the positioning element, which varies the separation (d) of the first and second light beams on the focusing element. Proximity problems, such as contamination, which result from the use of phase masks in contact mode are avoided. More generally, the interferometer provides a flexible source for large-area, non-focused interference patterns of tuneable period.

The invention relates to an interferometer for generating an interference pattern of tuneable period, more especially, but not exclusively, to an interferometer that can be used for writing Bragg gratings in optical fibres.

The technology and application of UV-written fibre Bragg gratings is widespread. The inscription of such devices into an optical fibre is reliant on an interference pattern of UV light with a period equal to that of the desired grating structure. Of increasing commercial importance is the use of chirped fibre Bragg gratings for dispersion compensation. Ideally these devices need to be several metres in length and have a bandwidth covering the bandwidth of an optical amplifier (typically >30 nm). The technology used to successfully fabricate long grating has not yet matured. In particular, there is still no established method of tuning the period of the UV interference pattern continuously over large bandwidths.

Some existing technologies of interest for fabricating such gratings are now described.

A π-phase mask is one popular technology used to generate a suitable interference pattern. A near-field interference pattern is produced that is periodic, with the dominant period being half that of the phase mask itself. While offering a stable and simple solution, gratings fabricated by direct use of a phase mask are inherently limited by the characteristics of the mask. Apodisation can be readily achieved with a standard phase mask, but the period of the grating is still predominantly determined by the period of the mask.

Chirped gratings can be produced with a phase mask if use is made of the effect that the period of the near-field interference pattern behind a phase mask is determined by the curvature of the incident wavefront. By using a defocused beam it is thus possible to tune the interference pattern. There are two major flaws with this design. First, the waveguide is in close proximity to the phase mask and contamination can still occur. Second, it is difficult to change the curvature of a wavefront without changing the spot size of the beam used. Changing the size of the writing beam, i.e. the spot size, during the fabrication of a grating can give inconsistent results.

Interferometric arrangements can, in principle, be used to write a grating without use of a phase mask. A beam splitter in combination with an interferometer can be used to generate two beams that intersect at an angle that leads to an interference pattern of the desired period. However, most known interferometers are relatively complex and typically rely on several movable parts to tune the period of the interference pattern.

WO-A-99/22256, on the other hand, provides a very simple interferometric arrangement. This arrangement is based on use of a phase mask which is positioned remote from the grating writing region, but imaged onto it. A single lens is used to remotely recombine the +/−1^{st} diffracted orders from a phase mask. Tuning of the interference pattern is achieved simply by translating the lens which is placed between the phase mask and the region where the optical fibre is situated for exposure. This apparatus has a limited practical tuning range. Specifically, tuning causes undesirable movement of the interference region.

In general, in order that the wavefronts are flat at the point of recombination it is necessary that the UV beam converges on the phase mask, i.e. that the UV beam is focused onto the phase mask or beyond it. The point at which the two diffracted orders recombine is a further focus. The use of such a system can be very advantageous in circumstances where a small beam diameter is required (e.g. in realising complex superstructure gratings) since the limited-depth interference pattern is not directly behind the phase mask. However, in the fabrication of broadband chirped fibre Bragg gratings, it is often desirable to use collimated light with a spot size of several hundred microns, or more, in order to decrease the sensitivity of the system to optical imperfections and slight translations of the waveguide during the fabrication process. More generally, it is desirable to have a relatively large beam incident on a phase mask to average out local imperfections in the phase mask.

It is therefore an object of the invention to provide an interferometer capable of creating an interference pattern of tuneable period, the period being tuneable over a large range without compromising the stability and location of the interference pattern.

According to a first aspect of the invention there is provided an interferometer apparatus comprising a beam source, and first and second interferometer arms for receiving first and second light beams from the beam source. The first arm of the interferometer includes first and second reflective surfaces arranged at right angles to each other to route the first light beam. The second arm of the interferometer is operatively associated with a positioner for causing relative motion between itself and the first arm. The apparatus further comprises a focusing element for combining the first and second light beams at an angle to form an interference pattern, wherein motion caused by the positioner varies the separation of the first and second light beams on the focusing element symmetrically about its optical axis, thereby to vary the period of the interference pattern by varying the angle of combining of the first and second light beams.

The beam source may comprise a phase mask, with the first and second light beams originating from corresponding positive and negative orders diffracted from the phase mask. Positive and negative first order diffracted beams are used in the best mode embodiment. A collimating lens may be provided as part of the beam source and arranged to collimate the positive and negative diffracted orders for input into the interferometer arms as the first and second light beams.

The second arm of the interferometer may comprise a third reflective surface arranged to direct the second light beam onto the focusing element, and optionally also a fourth reflective surface arranged at right angles to the third reflective surface so that the third and fourth reflective surfaces act in combination to reverse the second light beam.

In a preferred embodiment, the positioner forms a mount for the beam source and the second arm of the interferometer, but not for the focusing element and the first arm.

The apparatus of the first aspect of the invention is preferably operable to maintain the optical path length of the first light beam in the first arm equal to the optical path length of the second beam in the second arm under relative motion of the positioner. Furthermore, the optical path length of the first light beam in the first arm and the optical path length of the second beam in the second arm may be maintained constant under relative motion of the positioner.

The apparatus of the first aspect of the invention may be arranged so that the interference pattern is formed in a region that remains static under relative motion of the positioner.

According to a second aspect of the invention there is provided a method of generating an interference pattern. The method comprises:

(a) splitting a source of light into first and second light beams;

(b) routing the first light beam through a first optical path including first and second reflective surfaces;

(c) routine the second light beam through a second optical path;

(d) arranging a focusing element to receive on an input side thereof each of the first and second light beams in a direction parallel to its optical axis, with the first and second light beams being separated from the optical axis by first and second separation distances, respectively, which are equal to each other; and

(e) combining the first and second light beams on an output side of the focusing element to create an interference pattern in an interference region, the interference pattern having a desired period selected by choice of the first and second separation distances.

The method is preferably carried out such that the first optical path has a length equal to that of the second optical path.

Moreover, the period of the interference pattern is tuned in the best mode embodiment by changing the first and second optical paths so that the first and second separation distances are varied. Furthermore, the length of the first optical path and the length of the second optical path are preferably held constant during the tuning.

The tuning can be effected by a linear motion which may be generated by a single translational positioner, thereby to provide a very simple configuration, not only in terms of mechanical simplicity, but also in terms of the control electronics.

In the best mode embodiment, the first optical path includes a pair of reflective surfaces arranged at right angles to each other to reverse the first light beam. In another embodiment a pair of reflective surfaces is arranged parallel to each other.

According to a third aspect of the invention there is provided a method of manufacturing an optical waveguide grating, e.g. a fibre grating, or solid state waveguide grating, using an interference pattern generated according to the method of the second aspect of the invention incident on an optical fibre or solid state waveguide.

According to a fourth aspect of the invention there is provided a method of manufacturing a dispersion compensator using an interference pattern generated according to the method of the second aspect of the invention incident on a waveguide structure, such as an optical fibre or solid state waveguide.

According to a fifth aspect of the invention there is provided a method of manufacturing a phase mask using an interference pattern generated according to the method of the second aspect of the invention. Phase masks manufactured in this way are expected to have a high quality owing to the homogeneity, quality and stability of the interference pattern that can be generated by the apparatus and method of the first and second aspects of the invention.

An interferometer is thus provided that may be used to create an interference pattern that is tuneable in period. The interferometer may use a phase mask to provide the light beams, wherein a single phase mask can be used to generate interference patterns over a controllable range of periods by tuning of the interferometer.

In the preferred embodiment, the interferometer is tuneable over large ranges and uses only a standard, fixed period phase mask. Complex phase masks, such as chirped phase masks with spatially-variant period, are not required. Moreover, the preferred embodiment is implemented with only one movable stage.

The interferometer is such that large-diameter collimated beams of light may be used. This has the advantage that the process of grating inscription is tolerant to small optical defects. Small optical defects can cause significant problems if small-diameter beams or focused beams are used.

The interferometer offers a high degree of wavelength-tuneability while maintaining a balanced configuration. In this respect, a balanced configuration is one in which the optical path lengths of the two arms of the interferometer are kept equal to each other, so that there is immunity to the coherence length of light. Large tuneability can be achieved with only a single moving part in the form of a linear translation stage. This removes the problems of synchronisation associated with techniques based on conventional interferometers that use multiple translation stages.

The interference pattern is generated remote from the phase mask, alleviating the problems of phase mask-contamination from ablation of any particulates remaining on the waveguide after cleaning. This arrangement also has the benefit of generating a pure interference pattern by using only the +/−1^{st} diffracted orders from the phase mask.

The invention may find utility in producing optical fibre gratings, or gratings in other waveguide structures, such as planar waveguides. The invention may also find utility in the manufacture of phase masks.

For a better understanding of the invention and to show how the same may be carried into effect reference is now made by way of example to the accompanying drawings in which:

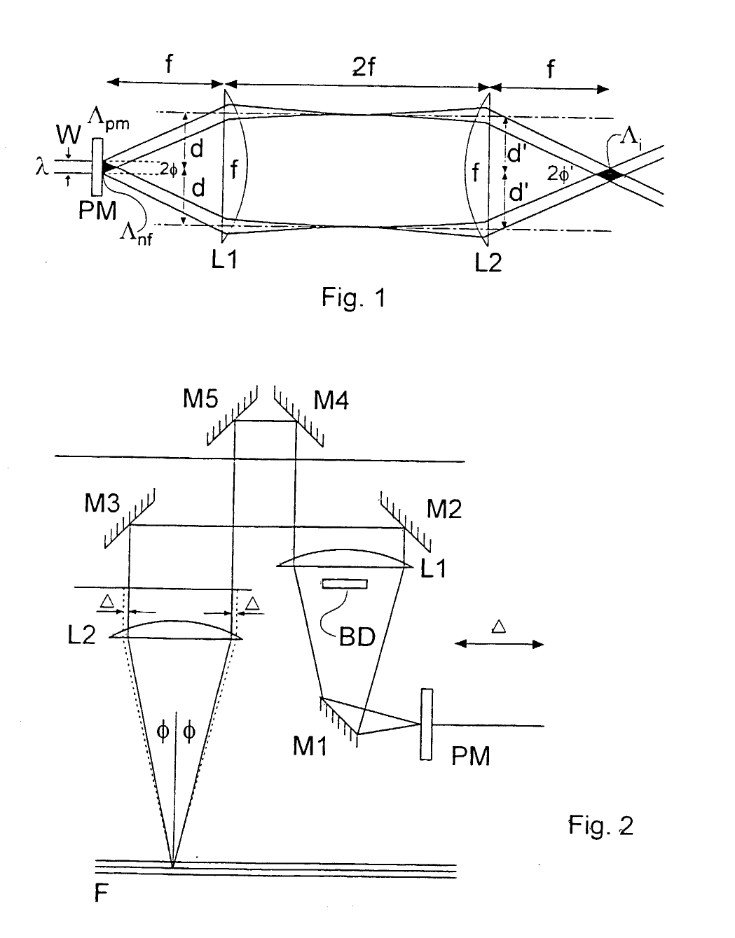

FIG. 1 is a schematic diagram of an optical arrangement used to explain the principles of the invention, in which arrangement the +/−1^{st} orders from a phase mask are remotely imaged using a collimated incident beam;

FIG. 2 is a diagram showing the optical arrangement of the interferometer of a first embodiment, and showing how the period of the interference pattern can be tuned; and

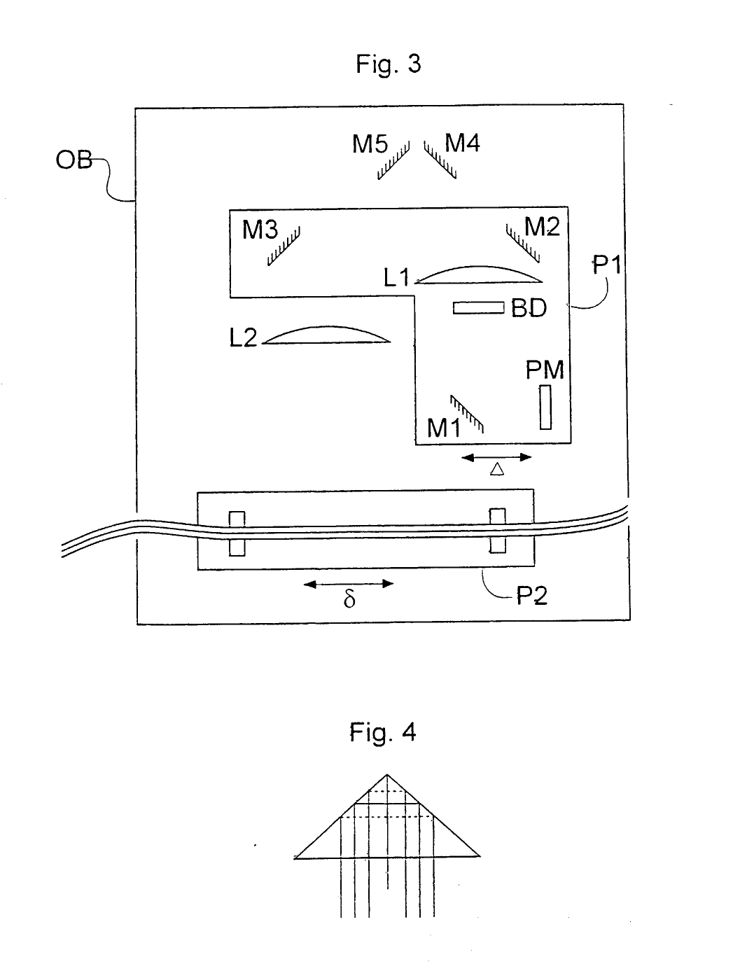

FIG. 3 shows the component layout of the optical arrangement of FIG. 2 in more detail;

FIG. 4 shows a corner-cube used to explain operation of the interferometer of FIG. 2, namely that the path length is constant regardless of the angular alignment of the corner cube relative to beams input to and output from the corner-cube;

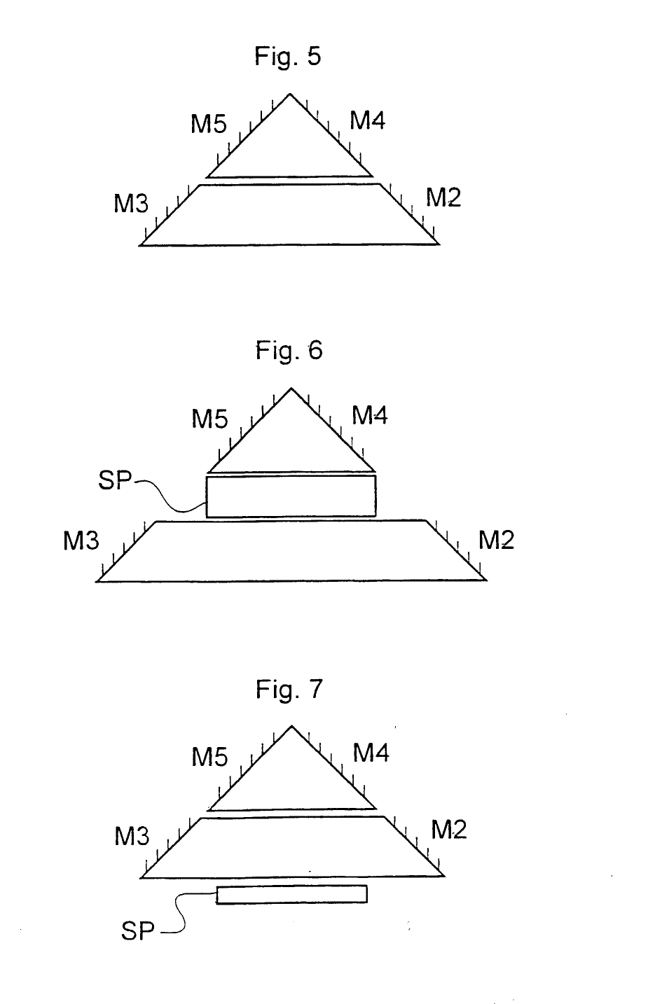

FIGS. 5, 6 and 7 show variants of the first embodiment using prisms;

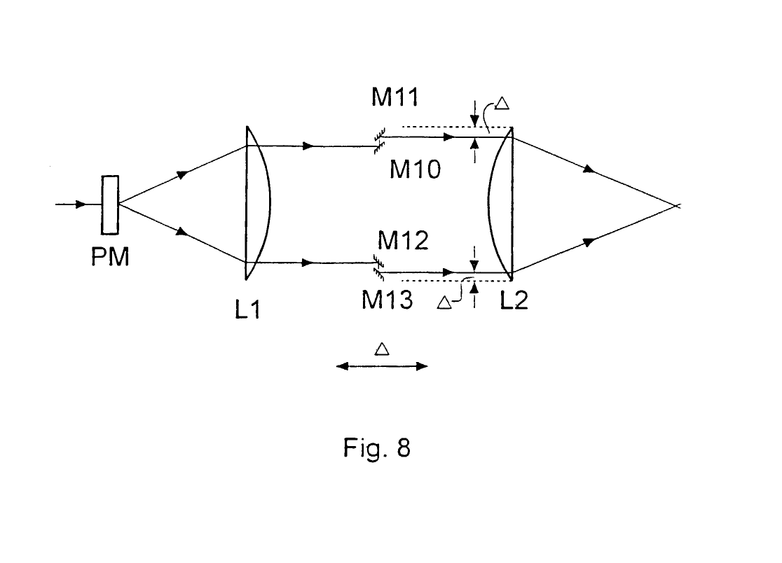

FIG. 8 shows a second embodiment of the invention.

### PRINCIPLES OF THE INVENTION

FIG. 1 shows a basic design for a non-tuneable interferometer. This design does not constitute and embodiment of the invention but is used to explain the principles underlying the invention.

The interferometer of FIG. 1 is based around two identical focusing elements in the form of lenses L1 and L2 that are used to remotely recombine two beams from a beam source, in this case the +/−1^{st} orders diffracted from a phase mask. These +/−1^{st} diffracted orders propagate as first and second light beams through respective first and second arms of the interferometer prior to their recombination to form an interference pattern.

A collimated beam of wavelength λ is incident normal to a phase mask, PM, which has a physical period Λₚₘ; a near-field interference pattern is produced with a nominal spatial period Λ_{nƒ} such that:

Λ_{nƒ}=Λₚₘ/2 (1)

In the far-field the +/−1^{st} diffracted orders from the phase mask subtend an angle φ to the optical axis where:

φ=sin⁻¹(λ/Λₚₘ) (2)

The +/−1^{st} orders are collected by lens L1 (focal length ƒ) placed at a distance ƒ from the front face of the phase mask. The distance of the beams from the optical axis at a distanced ƒ is give by:

d=ƒ tan(φ) (3)

A second lens L2 is placed at a distance 2ƒ from L1 such that the two parallel, but diverging, beams are recollimated and cross the optical axis at a distance ƒ behind L2. The resultant interference pattern formed by the two intersecting collimated beams has a period which is generally given by the expression:

Λᵢ=λ/2 sin(φ′) (4)

with:

φ′=tan⁻¹(d′/ƒ) (5)

Note that in this case d′ is equal to d and so Λᵢ is identical to Λ_{nƒ}.

This arrangement generates an interference pattern remote from the phase mask, which is desirable to prevent the ablation of contaminant material on the waveguide (such any remaining coating) onto the phase mask. The period of the interference pattern, Λᵢ, cannot be varied easily using such an arrangement. To achieve this it is necessary for the separation of the beams from the optical axis at the input of the L2 to be varied, such that the angle between the two beams at their point of intersection changes according to equation (5). It is also important to maintain the condition that the optical path length of both arms between L1 and L2 is 2ƒ in order that the beams are correctly collimated by L2 and to ensure that they intersect correctly at a distance ƒ behind L2. A further consideration is that the total path length from the phase mask to the point of intersection should be the same for the two beams: the interferometer is then said to be ‘balanced’ and is thus not limited by the coherence length of light.

First Embodiment

FIG. 2 shows an optical arrangement according to a first embodiment of the invention which is designed to allow tuning of the interference pattern while observing the two criteria highlighted above. The phase mask and optical elements M1, M2, M3, L1 are mounted on a linear translation stage. The left-hand beam incident on lens L2 moves in the same direction (and by the amount) as the linear translation stage; conversely the right-hand beam moves counter to the translation stage (but by the same magnitude). The effect of moving the translation stage by an amount Δ is thus to symmetrically translate the two beams of the interferometer by Δ about the optical axis of L2. The use of the two mirrors M4, M5 arranged at a right angle has the same effect as a corner-cube: the optical path length is maintained regardless of the position of the input beam (see FIG. 4). If the mirror-pairs M2,3 and M4,5 are aligned correctly then the arrangement is tolerant to angular misalignment since the input and output beams from the mirror-pairs will always be parallel.

The change in the separation d does not affect the location of the interference pattern, but does change its period as a result of the chance of the angle of convergence of the first and second beam.

A beam dump BD for blocking the zeroth order diffraction beam from the phase mask PM is also provided. In FIG. 2 it is shown positioned in front of the lens L1. The lens L1 is also arranged to avoid collection of 2nd and higher order beams. The design thus has the advantage that a pure interference pattern free of unwanted diffraction orders results.

FIG. 3 shows the component mounting of the optical arrangement of FIG. 2 in additional detail. A positioner P1 in the form of a linear translation stage operable to cause motion Δ mounts the previously mentioned components M1, M2, M3, PM, L1 and BD. An optical fibre F is mounted on a further positioner P2, also in the form of a linear translation stage with a section of the optical fibre arranged to be in the region of the interference pattern generated in the focal region of lens L2. The second positioner P2 will typically be arranged to cause motion δ parallel to that of the first positioner P1. The second positioner will typically be used to move the optical fibre F between different exposure positions. The positioner may also be driven during the grating exposure process to produce other effects such as chirping, as desired.

Example of Tuning Range

In theory it is desirable to have an interferometer with of the shortest possible optical path length in order that the interference pattern generated is as stable as possible. For practical reasons, however, it may be necessary to use a slightly longer interferometer. A realistic example is given here based around lenses with ƒ=70 mm: the total interferometer length is 280 mm (i.e. 4ƒ).

Normal Case (No Detuning):

| | |
|---|---|
| λ = 244 nm | |
| Λₚₘ = 1068 nm | Λ_{nf} = 534 nm |
| φ= 13.21° | |
| ƒ = 70 nm | |
| d = 16.43 mm | d' = d |
| Λᵢ = 534 mm | |
| Translation by 100 μm: | |
| Δ = 100 μm | |
| d' = d + Δ | |
| φ' = 13.29° | |
| Λᵢ = 530.85 nm | |

The Bragg wavelength (λ_{B}) of a grating written in a photosensitive waveguide is given by:

λ_{B}=2n_{eƒƒ}Λᵢ (6)

Thus for an arrangement similar to that of FIG. 2 employing lenses with a focal length of 70 mm, a 100 μm displacement of the translation stage gives a change in the Bragg wavelength of ˜9.14 nm (approximately 1 nm per 10 μm translation). Note that this gives tuning over 1520 nm to 1580 nm for approximately 0.8 mm translation.

Detuning rates of this magnitude are probably a reasonable compromise between a large tuning range and good stability. The detuning characteristic can be varied by the use of different focal length lenses.

Advantages

From the aforegoing it will be appreciated that the interferometer disclosed herein offers the following advantages:

(1) Use of a collimated UV beam allows large spot sizes, which in turn gives a large depth of interference and a high degree of multiple-exposure averaging during grating writing using the stroboscopic process described in WO-A-98/08120 and subsequent developments thereof.

(2) Tuning of the interference pattern is achieved using a single linear translation stage so that there is no need to synchronise several moving components.

(3) The position of the interference pattern remains constant when tuning the period, owing to the configuration of the interferometer.

(4) The respective optical path lengths of the two interferometer arms remain the same as each other under tuning, i.e. the interferometer arms are balanced. The design thus provides immunity to the coherence length of light and the stability of the interference pattern is increased.

(5) The respective optical path lengths of the two interferometer arms remain constant under tuning.

(6) The interferometer uses collimated light beams which makes a large tuning range possible without any chirping of the interference pattern that would be caused by converging/diverging beams.

(7) The use of only +/−n^{th} order diffracted beams, preferably the first order beams, gives a pure interference pattern. This compares favourably with the complex near-field pattern of a phase mask used in near contact mode which contains not only the positive and negative first order diffraction beams, but inevitably also higher orders, and the zeroth order. These residual diffracted orders are undesirable since they tend to produce artefacts in a grating produced using the phase mask.

(8) The light beam, e.g. UV beam, is stationary on the phase mask so the characteristics of the grating are not compromised by phase mask scanning.

Variants

In one variant of the embodiment of FIG. 2, the mirror M1 can be dispensed with so that the +/−1^{st} diffracted orders from the phase mask are launched directly onto the lens L1. Provision of the mirror M1 can however be useful in that it allows the light beam incident on the phase mask to avoid the fibre mounting region, and the alignment of the input light beam, possibly from a bulky laser, to be unaffected by motion of the positioner.

Other variants will use different beam sources. For example a beam splitter may be used in place of a phase mask.

FIG. 5 shows a further variant of the embodiment of FIG. 2. A prism having the shape of a right-angle triangle, that is a corner-cube, is shown in the upper part of the figure. The prism incorporates the mirror pair M4 and M5 which act by total internal reflection. The outer surfaces of the mirror faces may be metallised for example. A further prism incorporating the mirror pair M2 and M3 is shown in the lower part of the figure. It will be appreciated that one or both of the mirror pairs may be incorporated in a prism in this way. Use of prisms has the advantage of providing additional mechanical rigidity and stability of the relative positions and relative alignment of the mirrors of each mirror pair.

FIGS. 6 and 7 show other variants using prisms, where, in addition to the two prisms incorporating the two mirror pairs a spacing element SP is provided. The thickness of the spacing element is selected so that the optical path length of the first and second light beams through the interferometer are equal to each other. However, it will be understood that equal path lengths can be achieved without a separate spacer element, as in the arrangement of FIG. 5.

Second Embodiment

FIG. 8 shows a second embodiment of the invention which is described by way of its differences from the arrangement of FIG. 1. The arrangement of the second embodiment is the same as that of FIG. 1 except for the insertion of an inner mirror pair M10 and M12 and an outer mirror pair M11 and M13, where references to inner and outer are made with respect to the optical axis of the lenses L1 and L2. Each of the mirrors are arranged at 45 degrees to the optical axis with the inner mirror pair M10 and M12 facing the lens L1 and the outer mirror pair M11 and M13 facing the lens L2. The mirrors are arranged to displace the first and second light beams from the optical axis by equal amounts, the displacement being defined by the radial separation of mirrors M10 and M11 on the one hand and mirrors M12 and M13 on the other hand, the respective radial separations being equal.

The inner mirror pair M10 and M12 are mounted on a linear translation stage P1 (not shown) arranged to move the inner mirror pair parallel to the optical axis of the lenses L1 and L2, as indicated by the double-headed arrow and symbol Δ in the figure. Movement of the inner mirror pair M10 and M12 towards the lens L2 will cause the beams to be incident on the outer mirror pairs M11 and M13 at positions which are further radially outward of the optical axis. The light beams output from the outer mirror pair M11 and M13 will thus be moved out to further radially outward positions on the lens L2, as indicated by the dashed lines in the figure.

The second embodiment will thus provide a similar functionality to the first embodiment. As in the first embodiment, the second embodiment provides a balanced configuration with the optical path lengths of the two arms of the interferometer remaining the same as each other under tuning. Moreover, only a single positioner is needed to tune the interferometer, again similar to the first embodiment. However, in the second embodiment, unlike the first embodiment, the optical path lengths change on tuning rather than remaining constant as in the first embodiment. This is a disadvantage, since it will limit the tuning range since the optical path length between the lenses L1 and L2 will change. This could be compensated for by movement of the lens L1 and phase mask PM with the inner mirror pair, but this would add further complexity to the apparatus.

1. An interferometer apparatus comprising:
a beam source (PM, M1, L1) of first and second light beams;
a first arm for the first light beam, the first arm including first and second reflective surfaces (M4, M5) arranged to route the first light beam;
a second arm (M2, M3) for the second light beam, the second arm being operatively associated with a positioner (P1) for causing relative motion between the first arm and the second arm; and
a focusing element (L2) for combining the first and second light beams at an angle to form an interference pattern, wherein motion caused by the positioner varies the separation (d) of the first and second light beams on the focusing element symmetrically about its optical axis, thereby to vary the period of the interference pattern by varying the angle (φ) of combining of the first and second light beams.

2. An apparatus according to claim 1, wherein the focusing element receives the first and second light beams in a direction parallel to its optical axis.

3. An apparatus according to claim 1 or claim 2, wherein the beam source comprises a phase mask and the first and second light beams originate from corresponding positive and negative orders diffracted from the phase mask.

4. An apparatus according to claim 1, 2 or 3 wherein the beam source comprises a collimating lens (L1), arranged to input the first and second light beams from the phase mask to the first and second arms of the interferometer respectively.

5. An apparatus according to any one of claims 1 to 4, wherein the second arm comprises a third reflective surface (M3) arranged to direct the second light beam onto the focusing element.

6. An apparatus according to claim 5, wherein the second arm comprises a fourth reflective surface (M2) arranged at right angles to the third reflective surface so that the third and fourth reflective surfaces act in combination to reverse the second light beam.

7. An apparatus according to any one of claims 1 to 6, wherein the positioner forms a mount for the beam source and the second arm of the interferometer, but not for the focusing element and the first arm.

8. An apparatus according to any one of the preceding claims, operable to maintain the optical path length of the first light beam in the first arm equal to the optical path length of the second beam in the second arm under relative motion of the positioner.

9. An apparatus according to any one of the preceding claims, operable to maintain the optical path length of the first light beam in the first arm and the optical path length of the second beam in the second arm constant under relative motion of the positioner.

10. An apparatus according to any one of the preceding claims, wherein the interference pattern is formed in a region that remains static under relative motion of the positioner.

11. An apparatus according to any one of the preceding claims, wherein the first and second reflective surfaces are arranged at right angles to each other to reverse the first light beam.

12. An apparatus according to any one of claims 1 to 10, wherein the first and second reflective surfaces are arranged in parallel to each other to cause lateral deflection of the first light beam, the apparatus further comprising two further reflective surfaces arranged parallel to each other in the second arm to cause an opposite lateral deflection of the second light beam.

13. A method of generating an interference pattern comprising:
splitting a source of light into first and second light beams;
routing the first light beam through a first optical path including first and second reflective surfaces;
routing the second light beam through a second optical path;
arranging a focusing element to receive on an input side thereof each of the first and second light beams, with the first and second light beams being separated from the optical axis by first and second separation distances, respectively, which are equal to each other; and
combining the first and second light beams on an output side of the focusing element to create an interference pattern in an interference region, the interference pattern having a desired period selected by choice of the first and second separation distances.

14. A method according to claim 13, further comprising arranging the focusing element to receive the first and second light beams in a direction parallel to its optical axis.

15. A method according to claim 13 or claim 14, wherein the first optical path has a length equal to that of the second optical path.

16. A method according to claim 13, 14 or 15, further comprising:
tuning the period of the interference pattern by changing the first and second optical paths so that the first and second separation distances are varied.

17. A method according to claim 16, wherein the length of the first optical path and that of the second optical path remain constant during the tuning.

18. A method according to claim 16 or 17, wherein the tuning is effected by a linear motion.

19. A method according to claim 18, wherein the linear motion is generated by a single translational positioner.

20. A method according to any one of claims 13 to 19, wherein the first and second reflective surfaces are arranged at right angles to each other to reverse the first light beam.

21. A method according to any one of claims 13 to 19, wherein the first and second reflective surfaces are arranged parallel to each other to laterally deflect the first light beam.

22. A method of manufacturing an optical waveguide grating using an interference pattern generated according to the method of any one of claims 13 to 21 incident on an optical waveguide grating.

23. A method of manufacturing a dispersion compensator using an interference pattern generated according to the method of any one of claims 13 to 21 incident on a waveguide structure.

24. A method of manufacturing a phase mask using an interference pattern generated according to the method of any one of claims 13 to 21.
